(19) United States
(12) Patent Application Publication
(10) Pub. No.: US 2008/0293395 A1
(43) Pub. Date: Nov. 27, 2008

(54) USING DOWNLOADABLE SPECIFICATIONS TO RENDER A USER INTERFACE ON A MOBILE DEVICE

(75) Inventors: Ajit Mathews, Plantation, FL (US); Steven J. Nowlan, South Barrington, IL (US); William F. Zancho, Hawthorn Woods, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/751,421

(22) Filed: May 21, 2007

(51) Int. Cl. H04M 3/00; G06F 3/00

(52) U.S. Cl. 455/418; 715/700

(57) ABSTRACT

A representation is rendered on the user interface of a mobile device using a presentation specification and a behavior specification. The presentation specification defines styles, and the behavior specification defines interactions. Each specification can be used to set corresponding rules and libraries for rendering the user interface. The mobile device can communicate with one or more cellular radio networks and render the user interface using at least one new presentation and behavior specification downloaded and corresponding to a new cellular radio network.

### BACKGROUND OF THE INVENTION

1. Technical Field

The present inventions relate to mobile devices and, more particularly, relate to selectable user interface configurations therefore.

2. Description of the Related Art

Mobile cellular mobile communications is provided in different geographical areas by different service providers. Each provider has services and capabilities that are different or vary slightly from one another. Even the same service provider has differences between geographical areas.

Depending on the available services and capabilities on a mobile device certain features or capabilities may not be available.

What is needed is a way to adapt a mobile device and its user interface for changes in available services and capabilities when changing geographical regions or roaming across service providers.

### BRIEF DESCRIPTION OF THE DRAWINGS

Details of the inventions will be more readily understood from the following detailed description when read in conjunction with the accompanying drawings wherein:

FIG. 1 illustrates a schematic block diagram of a mobile device according to the present inventions;

FIG. 2 illustrates a schematic block diagram of a software stack of a mobile device according to the present inventions;

FIG. 3 illustrates a flow diagram of exemplary presentation and behavior specifications in memory according to the present inventions;

FIG. 4 illustrates exemplary presentation specification according to the present inventions;

FIG. 5 illustrates exemplary behavior specification according to the present inventions; and

FIG. 6 illustrates a flow diagram of the present inventions.

### DETAILED DESCRIPTION OF THE PREFERRED EMBODIMENTS

An object of the present inventions is to dynamically filter user interface representations of a mobile device.

A further object of the present inventions is to prioritize or de-prioritize a feature or service depending upon network conditions.

Another further object of the present inventions is to provide a seamless transition from one network to the network of another service provider.

Another object of the present inventions is to filter user interface representations when changing network capabilities.

A further other object of the present inventions is to dynamically change user interface experience depending upon a user interface filter rule set by a network.

The present inventions consider how to configure a user interface of a mobile device when it roams across service providers or changes geographical regions. When a mobile device roams across service providers or changes geographical regions, certain aspects of and certain features or capabilities may not be available.

A user interface can use feature capability specifications. These feature capability specifications can be dynamically read from a service provider and applied in a mobile device to automatically and quickly mask out unsupported features.

There are a variety of ways that this “masking” would be presented to the user. One is that in a graphical user interface unsupported options could be grayed out. Another is that in a graphical user interface unsupported options could be simply dropped from menu options. Similarly in a voice driven interface, unavailable options could be removed from the spoken grammars. The effect of this type of approach would be that a user would always get his familiar user interface, or a subset of that user interface—which is both easier to understand, re-learn and implement than trying to add in or otherwise unify additional features that may be available on a roamed network but not on the home network.

Two kinds of user interface specifications have been developed to provide this masking in a mobile device. The first kind is a presentation specification and the second kind is a behavior specification. The presentation specification is used to set presentation rules and libraries for the mobile device. The behavior specification is used to set behavior rules and libraries for the mobile device.

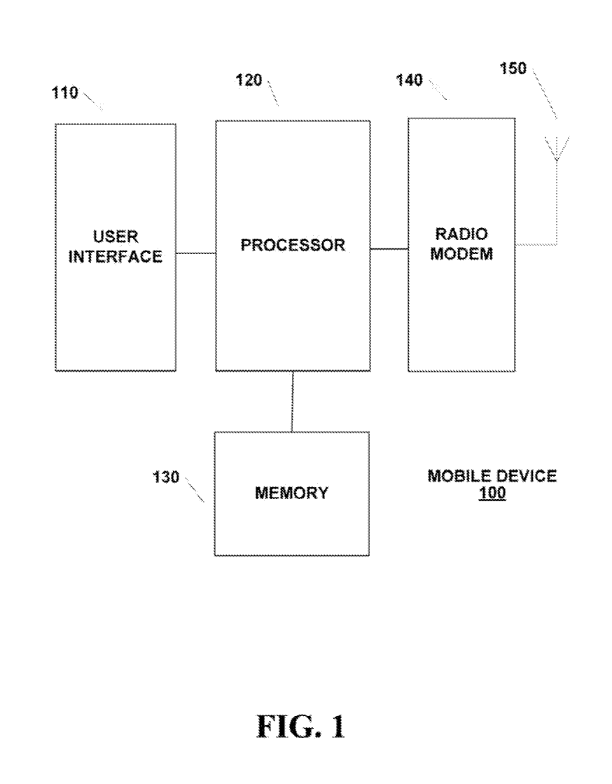

FIG. 1 illustrates a schematic block diagram of a mobile device according to the present inventions. A user interface 110 provides the man machine interface to a processor 120. A memory 130 couples to the processor 120. The processor is capable of rendering portions of the user interface 110 based on specifications or masks stored in the memory 130. A radio modem 140 communicates over a network via antenna 150. The processor 120 couples to the radio modem 140. A new presentation specification or new behavior specification can be identified by the processor 120 and downloaded over the radio modem 140 to update the mobile device 100. This is particularly useful when the mobile device 100 roams into a new network having different presentation or behavior requirement specifications.

An application or application manager in the mobile device 100 can have the ability to decipher a specification sent by the network operator for the network. A user experience engine has the ability to dynamically re-layout or change modalities of the user interface 110 in response to various specifications or masks applied to device. The underlying user interface architecture supports a dynamic compositional user interface. This permits behavioral components of a complex interface to be selectively disabled without impacting other, still supporting forms of interaction, or underlying application capabilities. This property of the compositional user interface supports the ability to change the user experience dynamically depending upon the specifications which may be set by the network.

An application, part of an application, or a feature that extends across multiple applications can be selectively turned on and off, dynamically, without need to reset or turn the device off. Further, the capabilities and features are turned off and then on again selectively, in response to roaming across different networks.

The present inventions provides a network operator with an easy method to specify a simple specification or mask which identifies features and sub-features which must be selectively disabled according to the capabilities of that operators network.

By the term specification, in both presentation specification and behavior specification, what is meant is a detailed, precise statement of particulars for the presentation or the behavior. A synonym for a specification in the context of these inventions could be a particularization or perhaps also a designation, a stipulation or a mask. A presentation specification is more specific than a presentation mask. A presentation specification is an instantiated presentation mask. To give a simple example, a presentation mask might specify a font style, like bold or italic, a presentation specification specifies the font fully, Helvetica bold 14. Similarly for a graphic screen, a mask might specify a soft-key label location anchor, like lower left corner, while the specification would describe the exact size and shape as well, i.e. rounded rectangle, 14 by 80 pixels, anchor-point lower left. Likewise, a behavior specification is more specific than a behavior mask. As an example, an MPD frame is a behavior mask, it actually needs additional information to be complete, which is actually specified in the declarative frame language grammars associated with the frame fields.

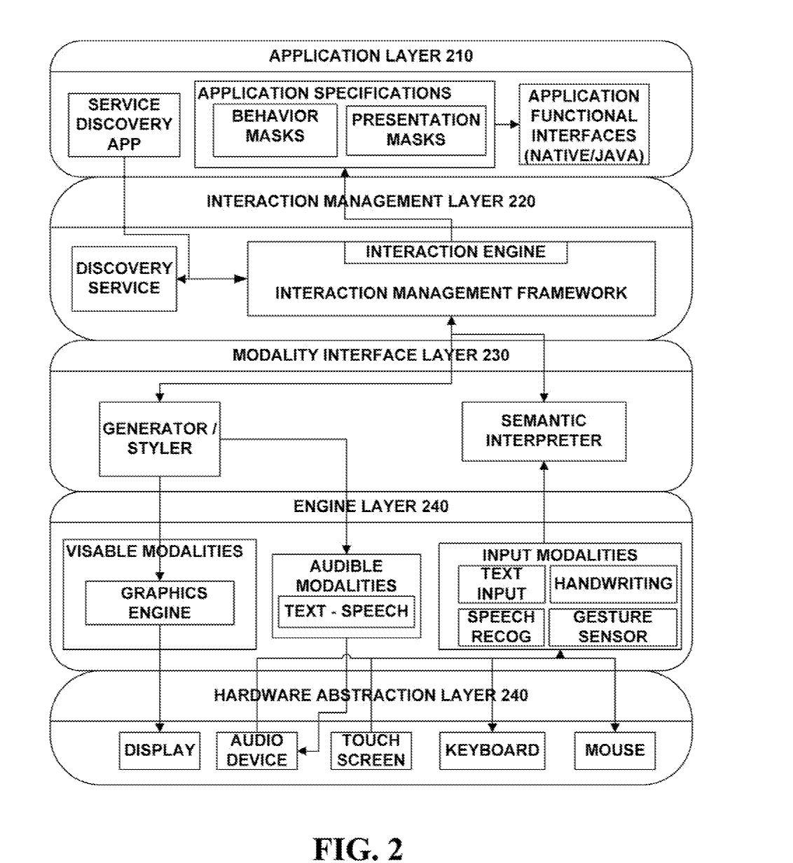

FIG. 2 illustrates a schematic block diagram of a software stack of a mobile device according to the present inventions and depicts an overall architecture of the user experience framework which supports the dynamic creation and sending of policies for prioritization of user experience requirements based on the environmental changes.

An application layer 210 has the clean separation of the behavior and the presentation specifications. That means the application behavior can be changed separately from the presentation specifications and vice versa. This is very important aspect of this framework for enabling the following: Sharing a common user experience across devices, and the ability to change the user experience dynamically (for example by environmentally driven policies).

An interaction management layer 220 is responsible for generating and updating the presentation by processing user inputs and possibly other external knowledge sources (examples are learning engine and context manager) to determine the intent of the user. This layer also consists of the constraint satisfaction engine which receives the constraints and imposes the constraints to various input and output device and modalities. The interaction management layer employs a compositional behavioral architecture in which the interaction flow for a specific application is composed of a number of independent goal and rule driven action elements. These elements may be selectively disabled without impacting the remaining enabled elements, providing a mechanism to rapidly mask out deep behavioral aspects of the user interface.

A modality interface layer 230 provides an interface between semantic representations of I/O processed by the interaction management layer and modality specific I/O content representations processed by the engine layer.

For output processing, an engine layer 240 converts the information from the styling component (in the interaction management layer) into a format that is easily understood by the user. For example, a graphics engine displays a vector of points as a curved line, and a speech synthesis system converts text into synthesized voice. For the input processing the engine layer captures natural input from the user and translates the input into a form useful for later processing. The engine layer consists of the rule based learning and context aware engine.

A device functionality layer 250 interfaces with device specific services such as CDMA stack, database etc. It is important to have a clean separation of the device functionality from the application and to ensure the application data are cleanly structured.

A hardware abstraction layer 260 illustrates the hardware of FIG. 1 for the mobile device such as the user interface shown by the exemplary touch screen, display, keyboard, mouse and audio device.

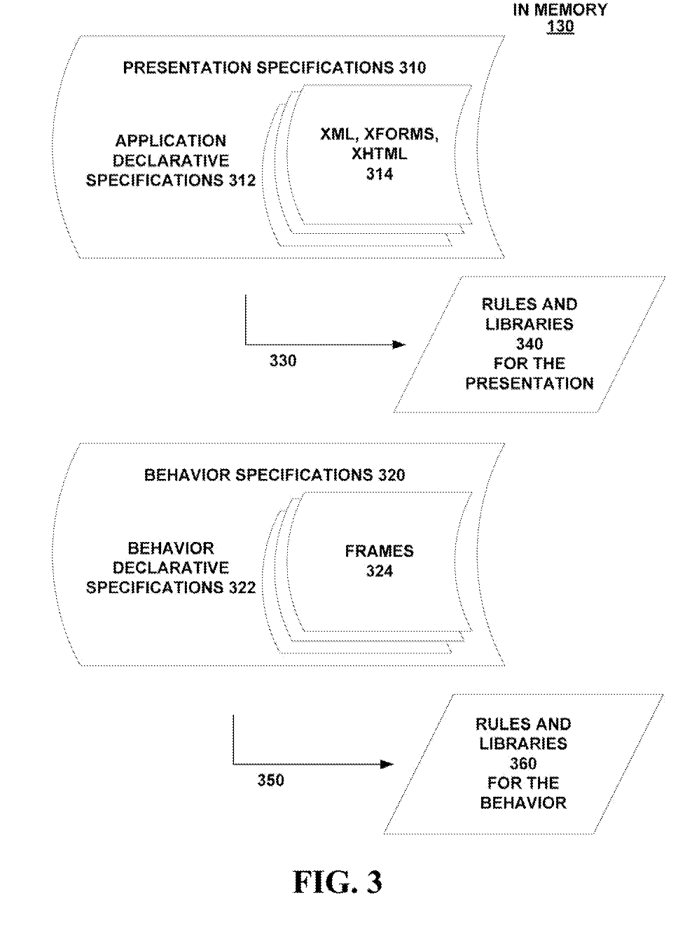

FIG. 3 illustrates a flow diagram of exemplary presentation and behavior specifications 310, 320 in the memory 130 according to the present inventions.

The presentation specifications 310 contain presentation and application declarative specifications 312. The presentation declarative specifications define how application data appears to the user, while the application declarative specifications 312 describe the structure of the data used in an application. For convenience we will refer to both as the presentation specification. The presentation declarative specifications are made up of a plurality of Extended Markup Language (XML) scripts 314. The XML script 314 can be expressed for example in XML, XFORMS or XHTML. Additionally other declarative specification languages can be used such as Flash™ by Adobe Systems Incorporated. The processor can be used to convert the presentation specifications 310 to rules and libraries 340 for the presentation stored in memory.

The presentation specification can define styles among look, language, volume, color, logos, artwork, font, haptics, key click, key sensitivity, key continuity, brightness, contrast, soft key layout, screen layout, haptic control layout, text to speech enablement, speech recognition enablement, choice of input method, including keypad, keyboard, handwriting, gesture, menu order, menu choices, localizations, time display preferences, date display preference and screen saver preference and any combinations of these.

The behavior specifications 320 contain behavior declarative specifications 322. The behavior declarative specifications are made up of a plurality of frames 324. The processor can be used to convert the behavior specifications 320 to rules and libraries 360 for the behavior stored in memory.

The behavior specification can define interactions among state machine flows, decision trees and condition-action rules, and any combinations of these.

The behavior specification comprises behavior declarative specifications among frame description language frames (including MPD frame language frames) and Harel state charts (including SCXML) and any combinations of these.

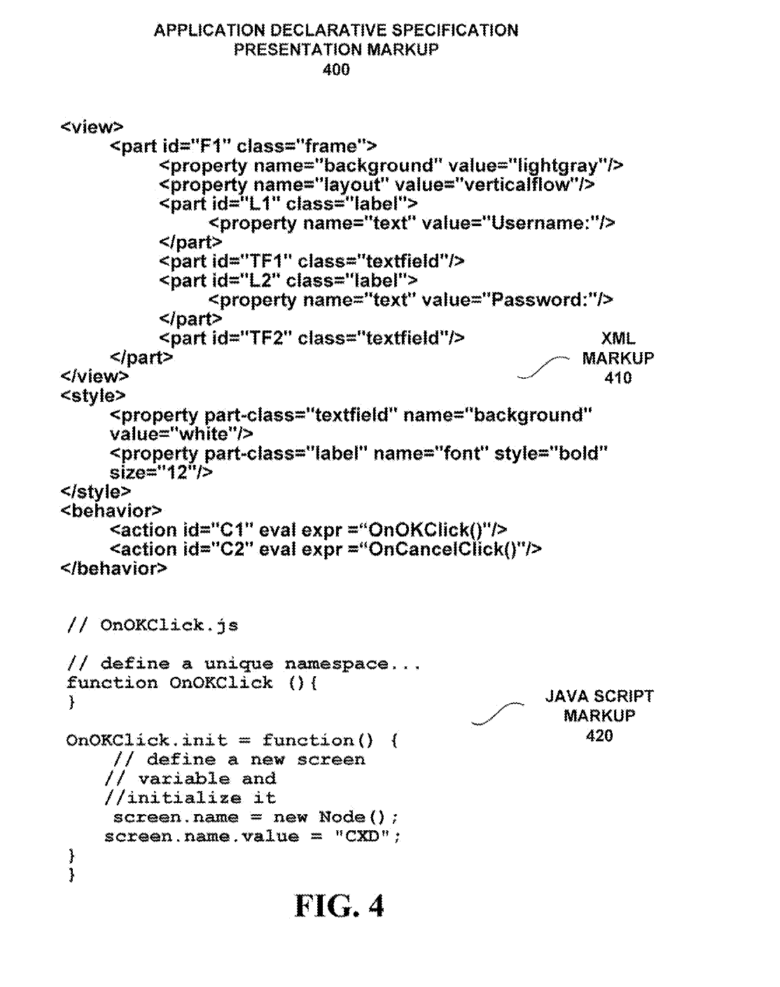

FIG. 4 illustrates exemplary presentation specifications according to the present inventions. The illustrated exemplary presentation specification 400 is written using Extended Markup Language (XML) and Java Script. The XML script is illustrated at 410. The Java Script expressions are illustrated at 420. The XML script can be expressed in XML, XFORMS or XHTML, or combinations of these.

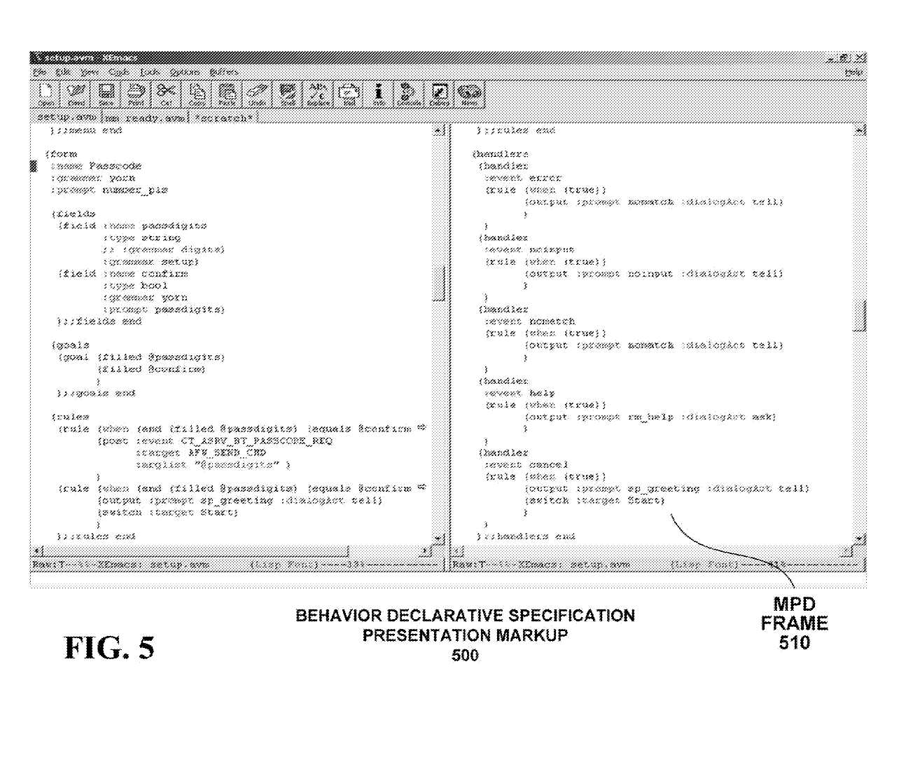

FIG. 5 illustrates exemplary behavior code according to the present inventions. The illustrated exemplary behavior code 500 is written using a version of a declarative frame language called Motorola Portable Dialog (MPD) frame language. An MPD frame 510 is written by the illustrated exemplary behavior code 500 in MPD form.

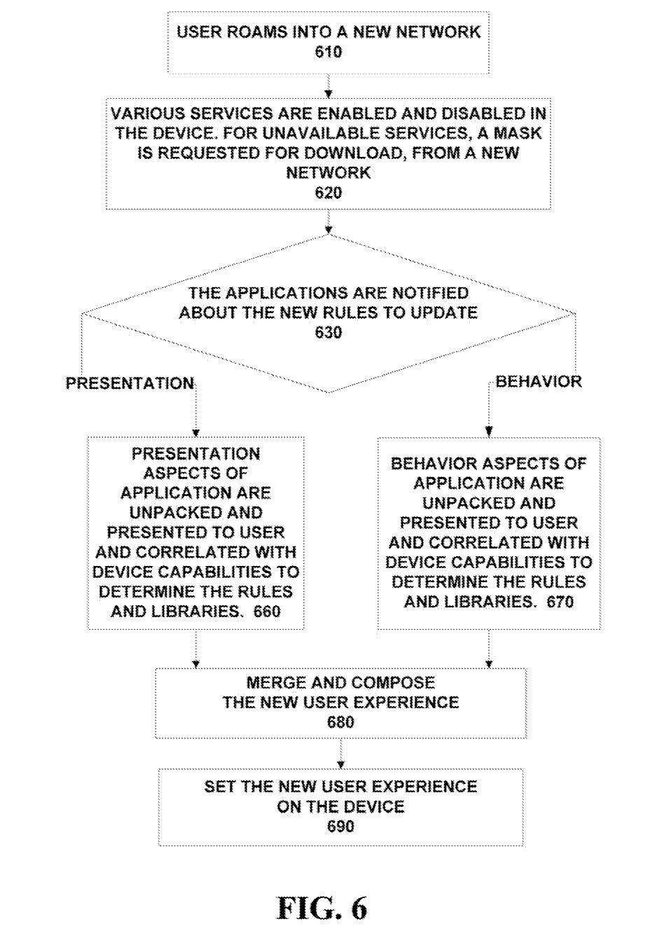

FIG. 6 illustrates a flow diagram according to the present inventions. A user roams into a new network at initial step 610. At step 620, the service discovery application looks up various filter rules specified by the new network operator and enables and disables various services in the device. If the services are not available the service discovery app makes a request to the download manager to receive user interface filter rules from the new network for the new services in the application layer. To select between presentation and behavior, at step 630, the service discovery application notifies the respective applications about the new rules and updates the appropriate specifications.

If presentation is selected, at step 660, the user experience manager unpacks the presentation aspects of the application and presents it to the user. The presentation specification is correlated with the device capabilities to determine the rules and libraries used to generate the presentation. The user will see the appropriate presentation aspects enabled/disabled at the interaction management layer.

If behavior is selected, at step 670, the user experience manager unpacks the behavior aspects of the application and presents it to the user. The behavioral specification is correlated with the device capabilities to determine the rules and libraries used to generate the behavior. The user will see the appropriate behavior aspects enabled/disabled at the interaction management layer.

Thereafter, at step 680, the new user experience is merged and composed to create the experience mask which is interpreted by the modality interface layer 230. At step 690, the new user experience is set on the device by the software informing the hardware drivers in application layer what to do.

Although the inventions have been described and illustrated in the above description and drawings, it is understood that this description is by example only, and that numerous changes and modifications can be made by those skilled in the art without departing from the true spirit and scope of the inventions. Although the examples in the drawings depict only example constructions and embodiments, alternate embodiments are available given the teachings of the present patent disclosure. The specifications can be co-located in a server which is particularly useful for a third generation networks which have sufficient data bandwidth.

What is claimed is:

1. A mobile device comprising:
a user interface for providing a representation;
a memory for storing at least a presentation specification defining style and a behavior specification defining interaction; and
a processor operatively coupled to the memory and the user interface to render the representation of the user interface using the presentation and behavior specifications stored in the memory.

2. A mobile device according to claim 1, wherein the presentation specification defines styles selected from the group consisting of look, language, volume, color, logos, artwork, font, haptics, key click, key sensitivity, key continuity, brightness, contrast, soft key layout, screen layout, haptic control layout, text to speech enablement, speech recognition enablement, choice of input method, including keypad, keyboard, handwriting, gesture, menu order, menu choices, localizations, time display preferences, date display preference and screen saver preference.

3. A mobile device according to claim 2, wherein the presentation specification comprises application declarative specifications of one or more of the group consisting of consisting of XML, XFORMS, XHTML and Flash.

4. A mobile device according to claim 1, wherein the behavior specification defines interactions selected from the group consisting of state machine flows, decision trees and condition-action rules.

5. A mobile device according to claim 4, wherein the behavior specification comprises behavior declarative specifications selected from the group consisting of declarative frame language frames and Harel state charts.

6. A mobile device according to claim 1,
wherein the processor renders the representation based on rules and libraries;
wherein the rules include both presentation rules and behavior rules;
wherein the libraries include both presentation libraries and behavior libraries;
wherein the processor uses at least one said presentation specification to set both the presentation rules and the presentation libraries; and
wherein the processor uses at least one said behavior specification to set both the behavior rules and the behavior libraries.

7. A mobile device according to claim 1,
wherein the mobile device further comprises a radio modem operatively coupled to the processor for communicating with at least one cellular radio network and capable of downloading a new presentation specification or behavior specification; and
wherein, when the mobile device communicates on a new cellular radio network, the processor determines if new presentation and behavior specifications are desired and accordingly renders the representation of the user interface using at least one new presentation and behavior specifications stored in the memory.

8. A mobile device according to claim 1, wherein the mobile device further comprises a modem operatively coupled to the memory for remotely obtaining one or more of the presentation and behavior specifications from a sever over a network.

9. A mobile device according to claim 8, wherein the processor determines if the presentation and behavior specifications locally stored in the memory are adequate and, if inadequate, querying the modem to download a new specification.

10. A mobile device according to claim 8, wherein the modem comprises a cellular radio transceiver.

11. A mobile device according to claim 1, wherein the processor determines if the locally stored presentation and behavior specifications are adequate upon provisioning the mobile device.

12. A mobile device according to claim 1, when changes occur in a network or an environment associated with the mobile device, the processor sets the presentation and behavior specifications

13. A mobile device according to claim 1, wherein the user interface is one or more of the group consisting of a display, an audio device, a touch screen, a keyboard and a mouse-like navigator.

14. A method of rendering a representation on the user interface of a mobile device, the method comprising the steps of:
(a) obtaining and storing in a memory of a mobile device at least a presentation specification defining style and a behavior specification defining interaction; and
(b) rendering a representation on a user interface of the mobile device using the presentation and behavior specifications stored in the memory.

15. A method according to claim 14,
wherein the presentation specification defines styles selected from the group consisting of look, language, volume, color, logos, artwork, font, haptics, key click, key sensitivity, key continuity, brightness, contrast, soft key layout, screen layout, haptic control layout, text to speech enablement, speech recognition enablement, choice of input method, including keypad, keyboard, handwriting, gesture, menu order, menu choices, localizations, time display preferences, date display preference and screen saver preference; and
wherein the behavior specification defines interactions selected from the group consisting of flow, decision tree and actions.

16. A method according to claim 14,
wherein said step (b) of rendering a representation on a user interface of the mobile device renders the representation based on rules and libraries, wherein the rules include both presentation rules and behavior rules, and wherein the libraries include both presentation libraries and behavior libraries, wherein at least one said presentation specification is used to set both the presentation rules and the presentation libraries, and wherein the processor uses at least one said behavior specification to set both the behavior rules and the behavior libraries.

17. A method according to claim 14, further comprising the steps of:
(c) communicating with one or more cellular radio networks and determining if the mobile device communicates on a new cellular radio network;
(d) when mobile device communicates on a new cellular radio network, determining if new presentation and behavior specifications are desired and accordingly rendering the representation of the user interface using at least one new presentation and behavior specifications stored in the memory to render a new representation on the user interface of the mobile device.

18. A method according to claim 14, further comprising the steps of:
(c) detecting when changes occur in a network or an environment associated with the mobile device; and
(d) setting new presentation and behavior specifications when changes occur in the network.

19. A method according to claim 14, wherein the presentation specification comprises application declarative specifications of one or more of the group consisting of XML, XFORMS, XHTML and Flash.

20. A method according to claim 14, wherein the behavior specification comprises behavior declarative specifications of frames.
